(19) United States
(12) Patent Application Publication
(10) Pub. No.: US 2025/0063340 A1
(43) Pub. Date: Feb. 20, 2025

(54) PRIORITIZATION OF EMISSION REQUIREMENTS BASED ON SPECIAL-PURPOSE FEATURES SUPPORTED BY A USER EQUIPMENT

(71) Applicant: Nokia Technologies Oy, Espoo (FI)

(72) Inventors: Rafhael MEDEIROS DE AMORIM, Aalborg (DK); Johannes HEJSELBAEK, Aalborg (DK); István Zsolt KOVÁCS, Aalborg (DK); Tero HENTTONEN, Espoo (FI); Petri Juhani VASENKARI, Espoo (FI)

(21) Appl. No.: 18/792,245

(22) Filed: Aug. 1, 2024

Related U.S. Application Data
(60) Provisional application No. 63/520,477, filed on Aug. 18, 2023.

(51) Int. Cl. H04W 8/22; H04W 48/08; H04W 64/00; H04W 84/06

(52) U.S. Cl. CPC H04W 8/22; H04W 48/08; H04W 64/006; H04W 84/06

(57) ABSTRACT

A method is provided that includes receiving system information at a user equipment (UE) operable in a network that serves a plurality of UEs. The UE is implemented as a specific-purpose that supports one or more specific-purpose features of the network, and the system information includes a list of network signaling (NS) values associated with respective emission requirements for radio frequency (RF) transmission by the plurality of UEs. The method includes selecting a specific-purpose NS value at the specific-purpose UE, with the specific-purpose NS value associated with an emission requirement for RF transmission by the specific-purpose UE. And the method includes applying the emission requirement for RF transmission by the specific-purpose UE. An associated apparatus that may be implemented as the special-purpose UE is also provided.

### TECHNOLOGICAL FIELD

The present disclosure relates generally to telecommunications and, in particular, to prioritization of emission requirements for radio frequency transmission by a user equipment based on specific-purpose features supported by the user equipment.

### BACKGROUND

A telecommunications system can be seen as a facility that enables communication sessions between two or more entities such as user terminals, base stations and/or other nodes by providing carriers between the various entities involved in the communications path. A telecommunications system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless telecommunications system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the telecommunications system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The telecommunications system and associated devices typically operate in accordance with a given standard or specification which sets out what the various entities associated with the system are permitted to do and how that should be achieved. Communication protocols and/or parameters which shall be used for the connection are also typically defined. One example of a telecommunications system is the Universal Mobile Telecommunications System (UMTS). Other examples of telecommunications systems are Long-Term Evolution (LTE), LTE Advanced and the so-called 5G or New Radio (NR) networks. NR is being standardized by the 3rd Generation Partnership Project (3GPP).

### BRIEF SUMMARY

Example implementations of the present disclosure are directed to telecommunications and, in particular, to prioritization of emission requirements for radio frequency transmission by a user equipment based on specific-purpose features supported by the user equipment. In this regard, the present disclosure includes, without limitation, the following example implementations.

Some example implementations provide an apparatus comprising: a memory configured to store computer-readable program code; and processing circuitry configured to access the memory, and execute the computer-readable program code to cause the apparatus to at least: receive system information at the apparatus operable in a network that serves a plurality of user equipments (UEs), the apparatus implemented as a specific-purpose UE that supports one or more specific-purpose features of the network, the system information including a list of network signaling (NS) values associated with respective emission requirements for radio frequency (RF) transmission by the plurality of UEs; select a specific-purpose NS value associated with an emission requirement for RF transmission by the specific-purpose UE; and apply the emission requirement for RF transmission by the apparatus.

Some example implementations provide an apparatus comprising: means for receiving system information at the apparatus operable in a network that serves a plurality of user equipments (UEs), the apparatus implemented as a specific-purpose UE that supports one or more specific-purpose features of the network, the system information including a list of network signaling (NS) values associated with respective emission requirements for radio frequency (RF) transmission by the plurality of UEs; means for selecting a specific-purpose NS value, the specific-purpose NS value associated with an emission requirement for RF transmission by the specific-purpose UE; and means for applying the emission requirement for RF transmission by the apparatus.

Some example implementations provide a method comprising: receiving system information at a user equipment (UE) operable in a network that serves a plurality of UEs, the UE implemented as a specific-purpose that supports one or more specific-purpose features of the network, the system information including a list of network signaling (NS) values associated with respective emission requirements for radio frequency (RF) transmission by the plurality of UEs; selecting a specific-purpose NS value at the specific-purpose UE, the specific-purpose NS value associated with an emission requirement for RF transmission by the specific-purpose UE; and applying the emission requirement for RF transmission by the specific-purpose UE.

Some example implementations provide a computer-readable storage medium that is non-transitory and has computer-readable program code stored therein that, in response to execution by processing circuitry, causes an apparatus to at least: receive system information at the apparatus operable in a network that serves a plurality of user equipments (UEs), implemented as a specific-purpose UE that supports one or more specific-purpose features of the network, the system information including a list of network signaling (NS) values associated with respective emission requirements for radio frequency (RF) transmission by the plurality of UEs; select a specific-purpose NS value associated with an emission requirement for RF transmission by the specific-purpose UE; and apply the emission requirement for RF transmission by the apparatus.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S)

Having thus described example implementations of the disclosure in general terms, reference will now be made to the accompanying figures, which are not necessarily drawn to scale, and wherein:

FIG. 1 illustrates a telecommunications system that includes one or more public land mobile networks (PLMNs) coupled to one or more external data networks, according to some example implementations of the present disclosure;

FIG. 2 illustrates a deployment of a PLMN that serves user equipment (UE), according to some example implementations;

FIG. 3 illustrates a deployment of a PLMN that includes one example of a specific-purpose UE, namely an aerial UE, according to some example implementations;

FIGS. 4A, 4B, 4C, 4D and 4E are flowcharts illustrating various steps in a method, according to various example implementations;

FIG. 5 illustrates an apparatus according to some example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be absolute or approximate to account for acceptable variations that may occur, such as those due to engineering tolerances or the like.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Furthermore, it should be understood that unless otherwise specified, the terms “data,” “content,” “digital content,” “information,” and similar terms may be at times used interchangeably. The term “network” may refer to a group of interconnected computers including clients and servers; and within a network, these computers may be interconnected directly or indirectly by various means including via one or more switches, routers, gateways, access points or the like.

Reference may be made herein to terms specific to a particular system, architecture or the like, but it should be understood that example implementations of the present disclosure may be equally applicable to any of a number of systems, architectures and the like. For example, reference may be made to 3GPP technologies such as Global System for Mobile Communications (GSM), UMTS, LTE, LTE Advanced and 5G NR; however, it should be understood that example implementations of the present disclosure may be equally applicable to non-3GPP technologies such as IEEE 802, Bluetooth and Bluetooth Low Energy.

Further, as used in this application, the term “circuitry” may refer to one or more or all of the following: (a) hardware-only circuit implementations (such as implementations in only analog and/or digital circuitry); (b) combinations of hardware circuits and software, such as (as applicable): (i) a combination of analog and/or digital hardware circuit(s) with software/firmware and (ii) any portions of hardware processor(s) with software (including digital signal processor(s)), software, and memory (ies) that work together to cause an apparatus, such as a mobile phone or server, to perform various functions); or (c) hardware circuit(s) and/or processor(s), such as a microprocessor(s) or a portion of a microprocessor(s), that requires software (e.g., firmware) for operation, but the software may not be present when it is not needed for operation.

The above definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

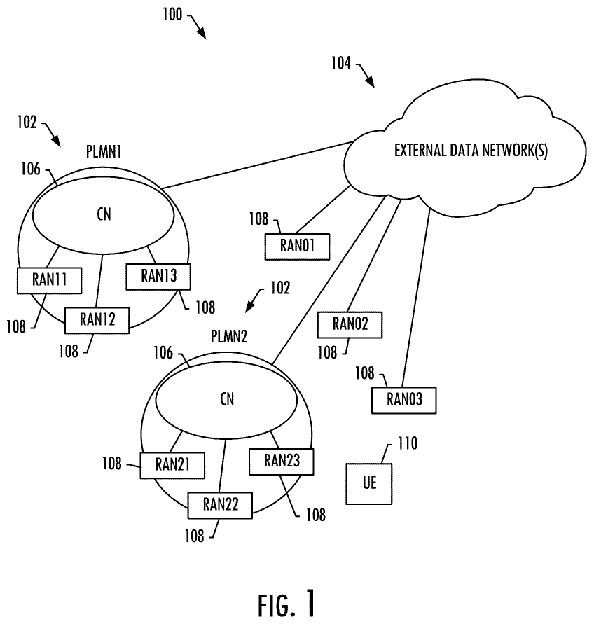

FIG. 1 illustrates a telecommunications system 100 according to various example implementations of the present disclosure. The telecommunications system generally includes one or more telecommunications networks. As shown, for example, the system includes one or more public land mobile networks (PLMNs) 102 coupled to one or more other external data networks 104—notably including a wide area network (WAN) such as the Internet. Each of the PLMNs includes a core network (CN) 106 backbone such as the Evolved Packet Core (EPC) of LTE, the 5G core network (5GC) or the like; and each of the core networks and the Internet are coupled to one or more radio access networks (RANs) 108, air interfaces or the like that implement one or more radio access technologies (RATs). As used herein, a “network device” refers to any suitable device at a network side of a telecommunications network. Examples of suitable network devices are described in greater detail below.

In addition, the system includes one or more radio units that may be varyingly known as user equipment (UE) 110, terminal device, terminal equipment, mobile station or the like. The UE is generally a device configured to communicate with a network device or a further UE in a telecommunication network. The UE may be a portable computer (e.g., laptop, notebook, tablet computer), mobile phone (e.g., cell phone, smartphone), wearable computer (e.g., smartwatch), or the like. In other examples, the UE may be an Internet of things (IoT) device, an industrial IoT (IIoT device), a vehicle equipped with a vehicle-to-everything (V2X) communication technology, or the like. In operation, these UEs may be configured to connect to one or more of the RANs 108 according to their particular radio access technologies to thereby access a particular CN 106 of a PLMN 102, or to access one or more of the external data networks 104 (e.g., the Internet). The external data network may be configured to provide Internet access, operator services, 3rd party services, etc. For example, the International Telecommunication Union (ITU) has classified 5G mobile network services into three categories: enhanced mobile broadband (eMBB), ultra-reliable and low-latency communications (URLLC), and massive machine type communications (mMTC) or massive internet of things (MIoT).

Examples of radio access technologies include 3GPP radio access technologies such as GSM, UMTS, LTE, LTE Advanced, and 5G NR. Other examples of radio access technologies include IEEE 802 technologies such as IEEE 802.11 (Wi-Fi), IEEE 802.15 (including 802.15.1 (WPAN/Bluetooth), 802.15.4 (Zigbee) and 802.15.6 (WBAN)), Bluetooth, Bluetooth Low Energy (BLE), ultra wideband (UWB), and the like. Generally, a radio access technology may refer to any 2G, 3G, 4G, 5G or higher generation mobile communication technology and their different versions, as well as to any other wireless radio access technology that may be arranged to interwork with such a mobile communication technology to provide access to the CN 106 of a mobile network operator (MNO).

In various example, a RAN 108 may be configured as one or more macrocells, microcells, picocells, femtocells or the like. The RAN may generally include one or more radio access nodes that are configured to interact with UEs 110. In various examples, a radio access node may be referred to as a base station (BS), access point (AP), base transceiver station (BTS), Node B (NB), evolved NB (eNB), macro BS, NB (MNB) or eNB (MeNB), home BS, NB (HNB) or eNB (HeNB), next generation NB (gNB), next generation eNB (ng-eNB), or the like. Some type of network controlling/governing entity responsible for control of the radio access nodes. The network controlling/governing entity and radio access node may be separate or integrated into a single apparatus. The network controlling/governing entity may include processing circuitry configured to carry out various management functions, etc. The processing circuitry may be associated with a computer-readable storage medium or database for maintaining information required in the management functions.

A RAN 108 may be centralized or distributed. In various examples, components of a RAN may be interconnected by Ethernet, Gigabit Ethernet, Asynchronous Transfer Mode (ATM), optical fiber, dark fiber, passive wavelength division multiplexing (WDM), WDM passive optical network (WDM-PON), optical transport network (OTN), time sensitive networking (TSN) and/or any other data link layer network, possibly including radio links. The RAN may be connected to a CN 106 through one or more gateways, network functions or the like.

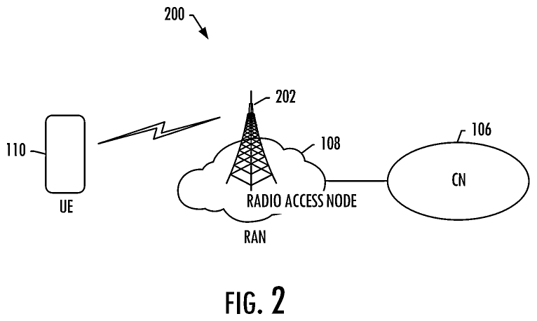

As will be appreciated, a PLMN 102 may be deployed in a number of different manners. FIG. 2 illustrates a deployment of a PLMN 200, such as a 4G LTE or 5G deployment, according to some example implementations. As shown, the deployment includes a CN 106, and RAN 108 with one or more radio access nodes 202 configured to interact with UEs 110. In a 4G LTE deployment, the EPC is the CN, and the evolved UMTS terrestrial radio access network (E-UTRAN) is the RAN; and the E-UTRAN includes one or more eNBs (radio access nodes) configured connect UEs to the E-UTRAN to thereby access the EPC. Similarly, in a 5G deployment, the 5GC is the CN 106, and the next generation (NG) radio access network (NG-RAN) is the RAN 108; and the NG-RAN includes one or more gNBs (radio access nodes 202) configured connect UEs 110 to the NG-RAN to thereby access the 5GC. The term ‘gNB’ in 5G may correspond to the eNB in 4G LTE.

Some deployments of 4G LTE and 5G in particular are considered standalone (SA) deployments. Other deployments combine 4G LTE and 5G technologies, and are referred to as non-standalone (NSA) deployments. In some deployments, the E-UTRAN includes one or more ng-eNBs that are configured to communicate with the 5GC, and that may also be configured to communicate with one or more gNBs. Similarly, in another deployment, the NG-RAN may include one or more en-gNBs that are configured to communicate with the EPC, and that may also be configured to communicate with one or more eNBs. In various instances, a single UE 110, a dual-mode or multimode UE, may support multiple (two or more) RANs-thereby being configured to connect to multiple RANs, such as 4G LTE and 5G.

In some deployments, operations of a radio access node 202 may be distributed or functionally split into components including one or more remote radio head (RRHs) or radio units (RUS), and a baseband unit (BBU); and in some architectures, the BBU may be split into a distributed unit (DU) and a central/centralized unit (CU), such as a server, host or node. In some architectures, the RRH/RU and DU may be collocated. It is also possible that node operations may be distributed among a plurality of servers, hosts or nodes.

It should also be understood that the distribution of work between CN 106 operations and radio access node 202 operations may vary depending on implementation. Thus, a 5G network architecture may be based on a so-called CU-DU split. One gNB-CU (central node) may control one or more gNB-DUs. The gNB-CU may control a plurality of spatially separated gNB-DUs, acting at least as transmit/receive (Tx/Rx) nodes. In some example implementations, however, the gNB-DUs (also called DU) may include, for example, a radio link control (RLC), medium access control (MAC) layer and a physical (PHY) layer, whereas the gNB-CU (also called a CU) may include the layers above the RLC layer, such as a packet data convergence protocol (PDCP) layer, a radio resource control (RRC), and an internet protocol (IP) layer. Other functional splits are also possible. It is considered that skilled person is familiar with the OSI model and the functionalities within each layer.

In some example implementations, the server or CU may generate a virtual network through which the server communicates with the radio node. In general, virtual networking may involve a process of combining hardware and software network resources and network functionality into a single, software-based administrative entity, a virtual network. Such virtual network may provide flexible distribution of operations between the server and the radio head/node. In practice, any digital signal processing task may be performed in either the CU or the DU, and the boundary where the responsibility is shifted between the CU and the DU may be selected according to implementation.

The PLMN 200 may use a number of operating (frequency) bands, and these operating bands may be arranged in channels over which radio transmission and reception may be carried. A UE 110 configured to connect to the PLMN may be subject to various radio frequency (RF) requirements, some of which may be different for different operating bands. In this regard, the UE may be categorized or classified in a power class that defines a maximum output power over a channel bandwidth, and the power class of the UE may be different for different operating bands of the PLMN. Relatedly, the UE may be allowed to reduce the maximum output power by an allowed maximum power reduction (MPR) due to higher order modulation and coding schemes (MCSs) and transmit bandwidth configurations.

In various examples, additional emission requirements may be signaled to the UE 110 by the PLMN 200. These additional emission requirements may be associated with respective network signaling (NS) values indicated in RRC signaling by the band number of the applicable operating band, and an associated value in an information element (e.g., additionalSpectrumEmission) of system information broadcast to the UE by the radio access node 202, such as in a system information block (SIB). To meet the additional requirements, an additional maximum power reduction (A-MPR) is allowed for the maximum output power, and the the total reduction to UE maximum output power may be characterized as max (MPR, A-MPR).

Due to support of multiple operating bands and allowing changes to NS values defined for an operating band after its introduction, the PLMN 200 may allow the use of multiple NS values for an operating band. This may be referred to as “multiNS”-support. The PLMN may therefore provide the UE 110 with a list of multiple NS values for an operating band, where the UE supports one or more of the multiple NS values. The UE may then select, from the list, one of the one or more NS values supported by the UE. More particularly, for example, the PLMN may provide the UE with an ordered list of NS values (multiNS-list) for an operating band, and the UE may select a first of one or more of the NS values supported by the UE.

Networks including 4G LTE and 5G are now starting to support devices designed for a specific purpose other than to communicate in a PLMN, but that have a wireless capability served by the PLMN. The PLMN may in turn include one or more specific-purpose features to support specific-purpose applications of these devices. In this regard, a specific-purpose UE may be defined as a UE 110 that supports one or more specific-purpose features of the network. In some cases, however, the specific-purpose feature(s) that support a specific-purpose UE may be subject to an emission requirement, such as A-MPR, that differs from other UEs served by the network. And in some of these cases, the NS values associated with respective emission requirements for the other UEs may not be adequate for a specific-purpose UE.

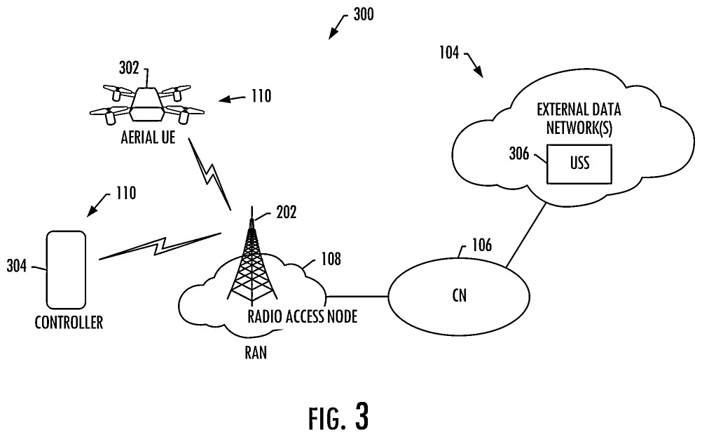

FIG. 3 illustrates a deployment of a PLMN 300 that includes one example of a specific-purpose UE, namely an aerial UE 302, according to some example implementations. In this regard, the aerial UE is a UE 110 capable of aerial communication. The aerial UE may be installed onboard an aircraft (aerial vehicle) designed to travel through the air (i.e., fly). The aircraft may be manned (crewed) or unmanned (uncrewed). An unmanned aerial vehicle (UAV), more commonly referred to as a drone, is one particular example of a suitable aircraft that has been discussed as being served by deployments of 4G LTE and 5G networks.

In some examples, the aerial UE 302 may be remotely controlled by a pilot or other operator using a controller 304. In the case of a UAV, the controller may be referred to as a UAV controller, and the UAV and UAV controller may form an unmanned aerial system (UAS). The controller may be a networked controller configured to connect to the aerial UE via the PLMN 300, in which case the controller may also be a UE; or in other examples, the controller may be a non-networked controller configured to connect to the aerial UE outside of the PLMN. An entity such as a UAS service supplier (USS) 306 may be connected to the PLMN by an external data network 104, and provide services to the pilot/operator in meeting any applicable UAS traffic management (UTM) requirements. In this regard, the USS may be a civil aviation authority (CAA) or operate under direction of a CAA.

The aerial UE 302 supports one or more aerial features of the PLMN 300. In a 4G LTE or 5G deployment, for example, the aerial feature(s) may require a subscription, and include one or more of subscription-based aerial UE identification and authorization, height reporting, location information reporting, interference detection, and/or signaling of flight path information. The aerial feature(s) support aerial applications in which the aerial UE is traveling through the air, and take into consideration the different propagation environment of the aerial UE. And as described herein, the height of the aerial UE may more particularly refer to the altitude of the UE.

For most of the aspects of the physical interface, the aerial UE 302 behaves similar to other UEs 110 served by the PLMN 300, except for the fact that the aerial UE travels through the air, more often transmitting “downwards” to the radio access node 202. The aerial UE may therefore be in line-of-sight with a number of radio access nodes in a given geographic area, which may increase the interference it causes (in uplink) and receives (on downlink). This increase in interference may lead to further limits on the aerial UE, in certain operating bands, for out of band emission, to protect the other systems such as satellite-based systems like meteorological satellite (MetSat) systems. And the NS values associated with respective emission requirements for the other UEs may not provide adequate protection.

An aerial UE 302 may support one or more NS values in the list of multiple NS values for an operating band, but the aerial UE may be subject to an emission requirement that differs from the emission requirement(s) associated with those NS value(s). The aerial UE may be configured to also support one or more aerial NS values (more generally specific-purpose NS value) that are only supported by aerial UEs, and the aerial NS value(s) may be provided in the list of multiple NS values without impact on other UEs 110 that do not support the aerial NS value(s).

It may be generally desirable for an aerial UE 302 to select an aerial NS value before other NS value(s) that the aerial UE supports. But in some examples in which an aerial UE supports an aerial NS value and another NS value in the list of multiple NS values, the aerial UE may not select the aerial NS value. In a manner similar to that described above for a UE 110, the aerial UE may select the other NS value instead of the aerial NS value, when the other NS value is listed before the aerial NS value in an ordered list of NS values. In this case, the aerial UE may apply the emission requirement associated with the other NS value, instead of the emission requirement associated with the aerial NS value. And in some examples, the NS values may not be reordered to place the aerial NS value before the other NS value.

According to some example implementations of the present disclosure, UEs 110 served by the PLMN 300 may be configured to implement a set of rules that specify how an aerial UE 302 is to select an NS value to make it more likely the aerial UE selects an aerial NS value. In some examples, the set of rules may include a first rule that specifies if the UE is an aerial UE, the UE will first select (and apply), among supported NS values in an ordered list of NS values, the first of the supported NS values that is an aerial NS value, regardless of its place in the ordered list (prioritization of NS value based on the specific-purpose features it supports). In some examples in which the ordered list of NS values does not include an aerial NS value, the aerial UE may follow a second rule in which the aerial UE selects the first of the supported NS values (legacy behavior followed by other UEs 110).

In some further examples, the aerial UE 302 may be provided with one or more aerial NS values that depend on the current time, the height (altitude) and/or the location of the aerial UE (e.g., time-, height- and/or location-dependent NS values), which the aerial UE may select at a specific time, when the aerial UE is within/above/below a specific height, and/or located within an indicated area. The location of the aerial UE may be expressed in one or more dimensions, such as in a one-dimensional (1D) location, two-dimensional (2D) location or three-dimensional (3D) location. In some examples, a location of the aerial UE may be indicated by a combination of its height and location. These aerial NS values may be useful in a number of examples, such as when operation of the aerial UE at a specific time, within/above/below a specific height, and/or located within an indicated area, is subject to a particular emission requirement.

In some examples, the list of multiple NS values may be provided in system information broadcast to the UEs 110 (including the aerial UE 302) by the radio access node 202. In some of these examples, the system information may also indicate whether specific aerial UEs should always follow the second rule (legacy behavior) or the first rule (for aerial NS value selection), or if the specific aerial UEs should follow another rule that specifies the specific aerial UEs ignore certain NS values that are broadcast. This other rule may be useful in situations in which the PLMN 300 looks to avoid the specific aerial UEs selecting particular NS values have caused errors. The system information that controls what rules the aerial UE follows may be broadcast in a SIB, such as in the block labeled as SIB type 1 (SIB1), which includes information relating to access restriction information of the UEs, and scheduling information for other SIBs.

As explained above, an aerial UE 302 may prioritize selection of an aerial NS value based on aerial/specific-purpose feature(s) supported by the UE. The selection of the aerial NS value (and application of the associated emission requirement) may be triggered at the aerial UE by an event such as receipt of system information including the list of NS values. In some examples, the aerial UE may be triggered by other events, in addition to or in lieu of receipt of the system information including the list of NS values.

In some examples, an aerial UE 302 may be triggered to select an aerial NS value when the aerial UE establishes access to the aerial feature(s), such as by performing subscription-based aerial UE identification and authorization towards the USS 306. In this regard, the aerial UE may support aerial feature(s), but the aerial UE may not perform an subscription-based aerial UE identification and authorization, until the aerial UE is expected to access to those aerial feature(s), such as at the start of a planned flight mission.

The aerial UE 302 may therefore be configured to select and apply another (non-aerial) NS value from the list of NS values, as any other UE 110, until the aerial UE establishes access to the aerial feature(s). The aerial UE may then be triggered to dynamically select and apply an aerial NS value. The aerial NS value may be as provided in the list of NS values; or in some examples, the aerial NS value may be provided in other signaling (e.g., RRC signaling) to the aerial UE, as part of or after performing its subscription-based aerial UE identification and authorization.

As indicated above, in some examples, the aerial UE 302 may be provided with one or more aerial NS values that depend on the current time, height and/or location of the aerial UE. In some of these examples, the aerial UE may be configured to select and apply a first aerial NS value. The aerial UE may monitor or otherwise determine the current time, its height and/or location; and when the aerial UE is operating at a specific time, within/above/below a specific height, and/or located within an indicated area, the aerial US may be triggered to dynamically select and apply a second aerial NS value associated with a second emission requirement for the aerial UE at its height and/or location.

Example implementations of the present disclosure therefore provide a UE 110 operable in a network (e.g., PLMN 300) that serves a plurality of UEs. The may be UE is implemented as a specific-purpose UE (e.g., aerial UE 302) that supports one or more specific-purpose features (e.g., aerial features) of the network. The specific-purpose UE may be configured to receive system information including a list of NS values associated with respective emission requirements for RF transmission by the plurality of UEs. The specific-purpose UE may be configured to select a specific-purpose NS value (e.g., aerial NS value) associated with an emission requirement for RF transmission by the specific-purpose UE, and apply the emission requirement for RF transmission by the specific-purpose UE.

In some examples, the specific-purpose NS value (e.g., aerial NS value) is selected from the list of NS values that includes the specific-purpose NS value. In some of these examples, the specific-purpose UE (e.g., aerial UE 302) supports a subset of the NS values, and the specific-purpose NS value is selected from the subset of the NS values that includes the specific-purpose NS value. In some further examples, the specific-purpose NS value is selected over at least one other NS value of the subset of the NS values. And in some examples in which the NS values have an order in the list of NS values, the subset of the NS values includes multiple specific-purpose NS values, and the specific-purpose NS value selected is a first of the multiple specific-purpose NS values in the order.

In some examples, the specific-purpose UE (e.g., aerial UE 302) is configured to receive one or more specific-purpose NS values (e.g., aerial NS values), independent of the list of NS values; and in some of these examples, the specific-purpose NS value is selected from the one or more specific-purpose NS values.

In some examples, the specific-purpose UE (e.g., aerial UE 302) may be configured to select an NS value from the list of NS values, and apply the one of the one of the respective emission requirements associated with the NS value for RF transmission by the specific-purpose UE. In some of these examples, as the one of the respective emission requirements is applied, the specific-purpose UE is configured to establish access of the specific-purpose UE to the one or more specific-purpose features (e.g., aerial features) of the network. The specific-purpose NS value may then be selected based on the access of the specific-purpose UE to the one or more specific-purpose features.

In some examples, the specific-purpose UE (e.g., aerial UE 302) is configured to determine at least one of a current time, an altitude (height) or a location of the specific-purpose UE. In some of these examples, the specific-purpose NS value (e.g., aerial NS value) is selected based on the at least one of the current time, the altitude or the location of the specific-purpose UE. And the specific-purpose NS value is associated with the emission requirement for RF transmission by the specific-purpose UE at the at least one of the current time, the altitude or the location.

Similarly, in some examples, as the emission requirement associated with the specific-purpose NS value is applied, the specific-purpose UE (e.g., aerial UE 302) is configured to determine at least one of a current time, an altitude or a location of the specific-purpose UE. In some of these examples, the specific-purpose UE is configured to select a second specific-purpose NS value, based on the at least one of the current time, the altitude or the location of the specific-purpose UE. The second specific-purpose NS value is associated with a second emission requirement for RF transmission by the specific-purpose UE at the at least one of the current time, the altitude or the location. And the specific-purpose UE is configured to apply the second emission requirement for RF transmission by the specific-purpose UE.

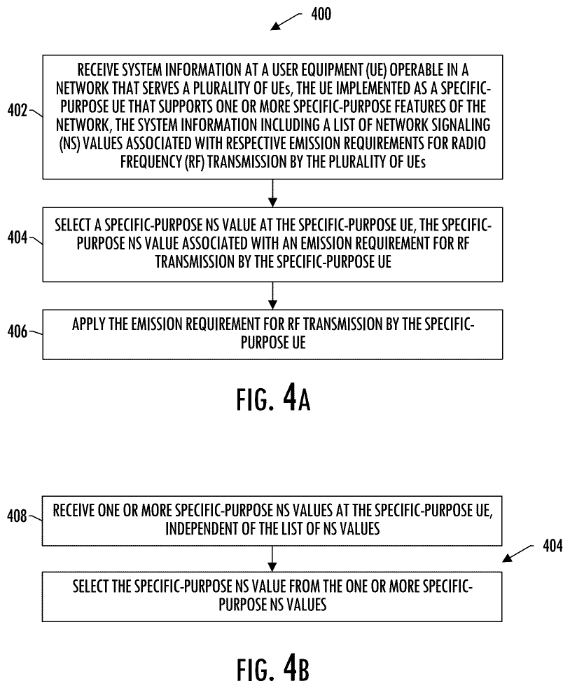

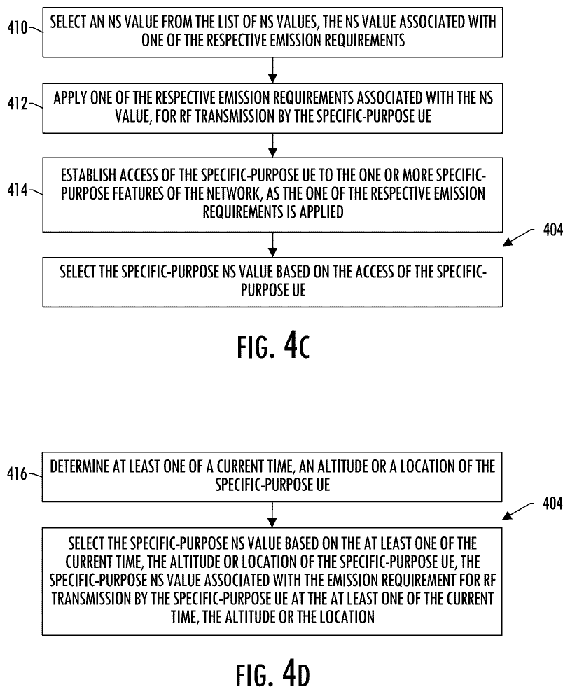

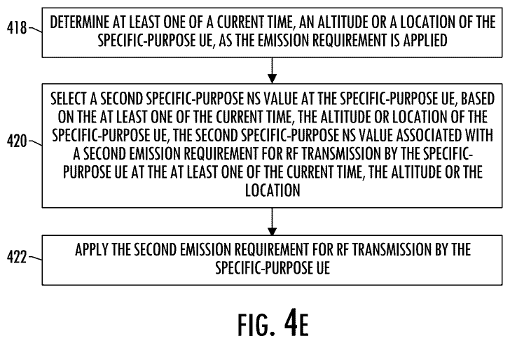

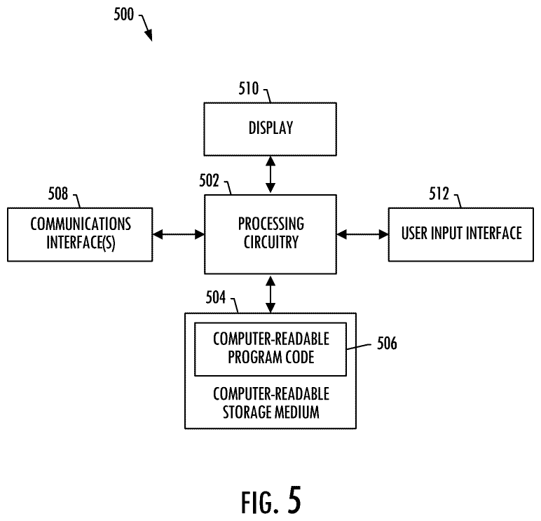

FIGS. 4A-4E are flowcharts illustrating various steps in a method 400, according to various example implementations. The method includes receiving system information at a user equipment (UE) operable in a network that serves a plurality of UEs, the UE implemented as a specific-purpose UE that supports one or more specific-purpose features of the network (e.g., aerial UE that supports one or more aerial features), as shown at block 402 of FIG. 4A. The system information includes a list of network signaling (NS) values associated with respective emission requirements for radio frequency (RF) transmission by the plurality of UEs. The method includes selecting a specific-purpose NS value at the specific-purpose UE, the specific-purpose NS value associated with an emission requirement for RF transmission by the specific-purpose UE, as shown at block 404. And the method includes applying the emission requirement for RF transmission by the specific-purpose UE, as shown at block 406.

In some examples, the specific-purpose NS value is selected at block 404 from the list of NS values that includes the specific-purpose NS value.

In some examples, the specific-purpose UE supports a subset of the NS values, and the specific-purpose NS value is selected at block 404 from the subset of the NS values that includes the specific-purpose NS value. In some further examples, the specific-purpose NS value is selected over at least one other NS value of the subset of the NS values.

In some examples, the NS values have an order in the list of NS values, and the subset of the NS values includes multiple specific-purpose NS values. In some of these examples, the specific-purpose NS value selected at block 404 is a first of the multiple specific-purpose NS values in the order.

In some examples, the method 400 further includes receiving one or more specific-purpose NS values at the specific-purpose UE, independent of the list of NS values, as shown at block 408 of FIG. 4B. In some of these examples, the specific-purpose NS value is selected at block 404 from the one or more specific-purpose NS values.

In some examples, the method 400 further includes selecting an NS value from the list of NS values, and the NS value is associated with one of the respective emission requirements, as shown at block 410 of FIG. 4C. In some of these examples, the method includes applying one of the respective emission requirements associated with the NS value, for RF transmission by the specific-purpose UE, as shown at block 412. The method includes establishing access of the specific-purpose UE to the one or more specific-purpose features of the network, as the one of the respective emission requirements is applied, as shown at block 414. And the specific-purpose NS value is selected at block 404 based on the access of the specific-purpose UE.

In some examples, the method 400 further includes determining at least one of a current time, an altitude or a location of the specific-purpose UE, as shown at block 416 of FIG. 4D. In some of these examples, the specific-purpose NS value is selected at block 404 based on the at least one of the current time, the altitude or the location of the specific-purpose UE. In this regard, the specific-purpose NS value is associated with the emission requirement for RF transmission by the specific-purpose UE at the at least one of the current time, the altitude or the location.

In some examples, the method 400 further includes determining at least one of a current time, an altitude or a location of the specific-purpose UE, as the emission requirement is applied, as shown at block 418 of FIG. 4E. In some of these examples, the method includes selecting a second specific-purpose NS value at the specific-purpose UE, based on the at least one of the current time, the altitude or the location of the specific-purpose UE, as shown at block 420. The second specific-purpose NS value is associated with a second emission requirement for RF transmission by the specific-purpose UE at the at least one of the current time, the altitude or the location. And the method includes applying the second emission requirement for RF transmission by the specific-purpose UE, as shown at block 422.

According to example implementations of the present disclosure, a telecommunications system 100 or PLMN 102, and its components such as a UE 110, CN 106, RAN 108, radio access node 202, aerial UE 302, controller 304 and/or USS 306, may be implemented by various means. Means for implementing the system and its components may include hardware, alone or under direction of one or more computer programs from a computer-readable storage medium, such as computer memory (or more simply “memory”). In some examples, one or more apparatuses may be configured to function as or otherwise implement the system and its components shown and described herein. In examples involving more than one apparatus, the respective apparatuses may be connected to or otherwise in communication with one another in a number of different manners, such as directly or indirectly via a wired or wireless network or the like.

FIG. 5 illustrates an apparatus 500 according to some example implementations of the present disclosure. Generally, an apparatus of exemplary implementations of the present disclosure may comprise, include or be embodied in one or more fixed or portable electronic devices. Examples of suitable electronic devices include a wearable computer, mobile phone, portable computer, desktop computer, workstation computer, server (server computer) or the like. The apparatus may include one or more of each of a number of components such as, for example, processing circuitry 502 connected to computer-readable storage medium 504.

The processing circuitry 502 may be composed of one or more processors alone or in combination with one or more computer-readable storage media. The processing circuitry is generally any piece of computer hardware that is capable of processing information such as, for example, data, computer programs and/or other suitable electronic information. The processing circuitry is composed of a collection of electronic circuits some of which may be packaged as an integrated circuit or multiple interconnected integrated circuits (an integrated circuit at times more commonly referred to as a “chip”). The processing circuitry may be configured to execute computer programs, which may be stored onboard the processing circuitry or otherwise stored in the computer-readable storage medium 504 (of the same or another apparatus).

The processing circuitry 502 may be a number of processors, a multi-core processor or some other type of processor, depending on the particular implementation. Further, the processing circuitry may be implemented using a number of heterogeneous processor systems in which a main processor is present with one or more secondary processors on a single chip. As another illustrative example, the processing circuitry may be a symmetric multi-processor system containing multiple processors of the same type. In yet another example, the processing circuitry may be embodied as or otherwise include one or more ASICs, FPGAs or the like. Thus, although the processing circuitry may be capable of executing a computer program to perform one or more functions, the processing circuitry of various examples may be capable of performing one or more functions without the aid of a computer program. In either instance, the processing circuitry may be appropriately programmed to perform functions or operations according to example implementations of the present disclosure.

The computer-readable storage medium 504 is generally any piece of computer hardware that is capable of storing information such as, for example, data, computer programs (e.g., computer-readable program code 506) and/or other suitable information either on a temporary basis and/or a permanent basis. The computer-readable storage medium may include volatile and/or non-volatile memory, and may be fixed or removable. Examples of suitable memory include random access memory (RAM), read-only memory (ROM), a hard drive, a flash memory, a thumb drive, a removable computer diskette, an optical disk or some combination of the above. The computer-readable storage medium is a non-transitory device capable of storing information, and is distinguishable from computer-readable transmission media such as electronic transitory signals capable of carrying information from one location to another. The term “non-transitory,” as used herein, is a limitation of the medium itself (i.e., tangible, not a signal) as opposed to a limitation on data storage persistency (e.g., RAM versus ROM). Computer-readable medium as described herein may generally refer to a computer-readable storage medium or computer-readable transmission medium.

In addition to the computer-readable storage medium 504, the processing circuitry 502 may also be connected to one or more interfaces for displaying, transmitting and/or receiving information. The interfaces may include a communications interface 508 and/or one or more user interfaces. The communications interface may be configured to transmit and/or receive information, such as to and/or from other apparatus(es), network(s) or the like. The communications interface may be configured to transmit and/or receive information by physical (wired) and/or wireless communications links. Examples of suitable communication interfaces include a network interface controller (NIC), wireless NIC (WNIC) or the like.

The user interfaces may include a display 510 and/or one or more user input interfaces 512. The display may be configured to present or otherwise display information to a user, suitable examples of which include a liquid crystal display (LCD), light-emitting diode (LED) display, organic LED (OLED) display, active-matrix OLED (AMOLED) or the like. The user input interfaces may be wired or wireless, and may be configured to receive information from a user into the apparatus, such as for processing, storage and/or display. Suitable examples of user input interfaces include a microphone, image or video capture device, keyboard or keypad, joystick, touch-sensitive surface (separate from or integrated into a touchscreen), biometric sensor or the like. The user interfaces may further include one or more interfaces for communicating with peripherals such as printers, scanners or the like.

As indicated above, program code instructions may be stored in a computer-readable storage medium, and executed by processing circuitry that is thereby programmed, to implement functions of the systems, subsystems, tools and their respective elements described herein. As will be appreciated, any suitable program code instructions may be loaded onto a computer or other programmable apparatus from a computer-readable storage medium to produce a particular machine, such that the particular machine becomes a means for implementing the functions specified herein. These program code instructions may also be stored in a computer-readable storage medium that can direct a computer, a processing circuitry or other programmable apparatus to function in a particular manner to thereby generate a particular machine or particular article of manufacture. The instructions stored in the computer-readable storage medium may produce an article of manufacture, where the article of manufacture becomes a means for implementing functions described herein. The program code instructions may be retrieved from a computer-readable storage medium and loaded into a computer, processing circuitry or other programmable apparatus to configure the computer, processing circuitry or other programmable apparatus to execute operations to be performed on or by the computer, processing circuitry or other programmable apparatus.

Retrieval, loading and execution of the program code instructions may be performed sequentially such that one instruction is retrieved, loaded and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processing circuitry or other programmable apparatus provide operations for implementing functions described herein.

Execution of instructions by a processing circuitry, or storage of instructions in a computer-readable storage medium, supports combinations of operations for performing the specified functions. In this manner, an apparatus 500 may include a processing circuitry 502 and a computer-readable storage medium 504 coupled to the processing circuitry, where the processing circuitry is configured to execute computer-readable program code 506 stored in the computer-readable storage medium. It will also be understood that one or more functions, and combinations of functions, may be implemented by special purpose hardware-based computer systems and/or processing circuitry which perform the specified functions, or combinations of special purpose hardware and program code instructions.

As explained above and reiterated below, the present disclosure includes, without limitation, the following example implementations.

Clause 1. An apparatus comprising: a memory configured to store computer-readable program code; and processing circuitry configured to access the memory, and execute the computer-readable program code to cause the apparatus to at least: receive system information at the apparatus operable in a network that serves a plurality of user equipments (UEs), the apparatus implemented as a specific-purpose UE that supports one or more specific-purpose features of the network, the system information including a list of network signaling (NS) values associated with respective emission requirements for radio frequency (RF) transmission by the plurality of UEs; select a specific-purpose NS value associated with an emission requirement for RF transmission by the specific-purpose UE; and apply the emission requirement for RF transmission by the apparatus.

Clause 2. The apparatus of clause 1, wherein the specific-purpose UE is an aerial UE, and the one or more specific-purpose features are aerial features of the network.

Clause 3. The apparatus of clause 1 or clause 2, wherein the specific-purpose NS value is selected from the list of NS values that includes the specific-purpose NS value.

Clause 4. The apparatus of clause 3, wherein apparatus supports a subset of the NS values, and the specific-purpose NS value is selected from the subset of the NS values that includes the specific-purpose NS value.

Clause 5. The apparatus of clause 4, wherein the specific-purpose NS value is selected over at least one other NS value of the subset of the NS values.

Clause 6. The apparatus of clause 4 or clause 5, wherein the NS values have an order in the list of NS values, the subset of the NS values includes multiple specific-purpose NS values, and the specific-purpose NS value selected is a first of the multiple specific-purpose NS values in the order.

Clause 7. The apparatus of any of clauses 1 to 6, wherein the processing circuitry is configured to execute the computer-readable program code to cause the apparatus to further receive one or more specific-purpose NS values, independent of the list of NS values, and wherein the specific-purpose NS value is selected from the one or more specific-purpose NS values.

Clause 8. The apparatus of any of clauses 1 to 7, wherein the processing circuitry is configured to execute the computer-readable program code to cause the apparatus to further at least: select an NS value from the list of NS values, the NS value associated with one of the respective emission requirements; apply one of the respective emission requirements associated with the NS value, for RF transmission by the apparatus; and establish access of the apparatus to the one or more specific-purpose features of the network, as the one of the respective emission requirements is applied, and wherein the specific-purpose NS value is selected based on the access of the apparatus.

Clause 9. The apparatus of any of clauses 1 to 8, wherein the processing circuitry is configured to execute the computer-readable program code to cause the apparatus to further determine at least one of a current time, an altitude or a location of the apparatus, and wherein the specific-purpose NS value is selected based on the at least one of the current time, the altitude or the location of the apparatus, the specific-purpose NS value associated with the emission requirement for RF transmission by the specific-purpose UE at the at least one of the current time, the altitude or the location.

Clause 10. The apparatus of any of clauses 1 to 9, wherein the processing circuitry is configured to execute the computer-readable program code to cause the apparatus to further at least: determine at least one of a current time, an altitude or a location of the apparatus, as the emission requirement is applied; select a second specific-purpose NS value, based on the at least one of the current time, the altitude or the location of the apparatus, the second specific-purpose NS value associated with a second emission requirement for RF transmission by the specific-purpose UE at the at least one of the current time, the altitude or the location; and apply the second emission requirement for RF transmission by the apparatus.

Clause 11. An apparatus comprising: means for receiving system information at the apparatus operable in a network that serves a plurality of user equipments (UEs), the apparatus implemented as a specific-purpose UE that supports one or more specific-purpose features of the network, the system information including a list of network signaling (NS) values associated with respective emission requirements for radio frequency (RF) transmission by the plurality of UEs; means for selecting a specific-purpose NS value, the specific-purpose NS value associated with an emission requirement for RF transmission by the specific-purpose UE; and means for applying the emission requirement for RF transmission by the apparatus.

Clause 12. The apparatus of clause 11, wherein the specific-purpose UE is an aerial UE, and the one or more specific-purpose features are aerial features of the network.

Clause 13. The apparatus of clause 11 or clause 12, wherein the specific-purpose NS value is selected from the list of NS values that includes the specific-purpose NS value.

Clause 14. The apparatus of clause 13, wherein the apparatus supports a subset of the NS values, and the specific-purpose NS value is selected from the subset of the NS values that includes the specific-purpose NS value.

Clause 15. The apparatus of clause 14, wherein the specific-purpose NS value is selected over at least one other NS value of the subset of the NS values.

Clause 16. The apparatus of clause 14 or clause 15, wherein the NS values have an order in the list of NS values, the subset of the NS values includes multiple specific-purpose NS values, and the specific-purpose NS value selected is a first of the multiple specific-purpose NS values in the order.

Clause 17. The apparatus of any of clauses 11 to 16, wherein the apparatus further comprises means for receiving one or more specific-purpose NS values, independent of the list of NS values, and wherein the specific-purpose NS value is selected from the one or more specific-purpose NS values.

Clause 18. The apparatus of any of clauses 11 to 17, wherein the apparatus further comprises: means for selecting an NS value from the list of NS values, the NS value associated with one of the respective emission requirements; means for applying one of the respective emission requirements associated with the NS value, for RF transmission by the apparatus; and means for establishing access of the apparatus to the one or more specific-purpose features of the network, as the one of the respective emission requirements is applied, and wherein the specific-purpose NS value is selected based on the access of the apparatus.

Clause 19. The apparatus of any of clauses 11 to 18, wherein the apparatus further comprises means for determining at least one of a current time, an altitude or a location of the apparatus, and wherein the specific-purpose NS value is selected based on the at least one of the current time, the altitude or the location of the apparatus, the specific-purpose NS value associated with the emission requirement for RF transmission by the specific-purpose UE at the at least one of the current time, the altitude or the location.

Clause 20. The apparatus of any of clauses 11 to 19, wherein the apparatus further comprises: means for determining at least one of a current time, an altitude or a location of the apparatus, as the emission requirement is applied; means for selecting a second specific-purpose NS value, based on the at least one of the current time, the altitude or the location of the apparatus, the second specific-purpose NS value associated with a second emission requirement for RF transmission by the specific-purpose UE at the at least one of the current time, the altitude or the location; and means for applying the second emission requirement for RF transmission by the apparatus.

Clause 21. A method comprising: receiving system information at a user equipment (UE) operable in a network that serves a plurality of UEs, the UE implemented as a specific-purpose that supports one or more specific-purpose features of the network, the system information including a list of network signaling (NS) values associated with respective emission requirements for radio frequency (RF) transmission by the plurality of UEs; selecting a specific-purpose NS value at the specific-purpose UE, the specific-purpose NS value associated with an emission requirement for RF transmission by the specific-purpose UE; and applying the emission requirement for RF transmission by the specific-purpose UE.

Clause 22. The method of clause 21, wherein the specific-purpose UE is an aerial UE, and the one or more specific-purpose features are aerial features of the network.

Clause 23. The method of clause 21 or clause 22, wherein the specific-purpose NS value is selected from the list of NS values that includes the specific-purpose NS value.

Clause 24. The method of clause 23, wherein the specific-purpose UE supports a subset of the NS values, and the specific-purpose NS value is selected from the subset of the NS values that includes the specific-purpose NS value.

Clause 25. The method of clause 24, wherein the specific-purpose NS value is selected over at least one other NS value of the subset of the NS values.

Clause 26. The method of clause 24 or clause 25, wherein the NS values have an order in the list of NS values, the subset of the NS values includes multiple specific-purpose NS values, and the specific-purpose NS value selected is a first of the multiple specific-purpose NS values in the order.

Clause 27. The method of any of clauses 21 to 26, wherein the method further comprises receiving one or more specific-purpose NS values at the specific-purpose UE, independent of the list of NS values, and wherein the specific-purpose NS value is selected from the one or more specific-purpose NS values.

Clause 28. The method of any of clauses 21 to 27, wherein the method further comprises: selecting an NS value from the list of NS values, the NS value associated with one of the respective emission requirements; applying one of the respective emission requirements associated with the NS value, for RF transmission by the specific-purpose UE; and establishing access of the specific-purpose UE to the one or more specific-purpose features of the network, as the one of the respective emission requirements is applied, and wherein the specific-purpose NS value is selected based on the access of the specific-purpose UE.

Clause 29. The method of any of clauses 21 to 28, wherein the method further comprises determining at least one of a current time, an altitude or a location of the specific-purpose UE, and wherein the specific-purpose NS value is selected based on the at least one of the current time, the altitude or the location of the specific-purpose UE, the specific-purpose NS value associated with the emission requirement for RF transmission by the specific-purpose UE at the at least one of the current time, the altitude or the location.

Clause 30. The method of any of clauses 21 to 29, wherein the method further comprises: determining at least one of a current time, an altitude or a location of the specific-purpose UE, as the emission requirement is applied; selecting a second specific-purpose NS value at the specific-purpose UE, based on the at least one of the current time, the altitude or the location of the specific-purpose UE, the second specific-purpose NS value associated with a second emission requirement for RF transmission by the specific-purpose UE at the at least one of the current time, the altitude or the location; and applying the second emission requirement for RF transmission by the specific-purpose UE.

Clause 31. A computer-readable storage medium that is non-transitory and has computer-readable program code stored therein that, in response to execution by processing circuitry, causes an apparatus to at least: receive system information at the apparatus operable in a network that serves a plurality of user equipments (UEs), implemented as a specific-purpose UE that supports one or more specific-purpose features of the network, the system information including a list of network signaling (NS) values associated with respective emission requirements for radio frequency (RF) transmission by the plurality of UEs; select a specific-purpose NS value associated with an emission requirement for RF transmission by the specific-purpose UE; and apply the emission requirement for RF transmission by the apparatus.

Clause 32. The computer-readable storage medium of clause 31, wherein the specific-purpose UE is an aerial UE, and the one or more specific-purpose features are aerial features of the network.

Clause 33. The computer-readable storage medium of clause 31 or clause 32, wherein the specific-purpose NS value is selected from the list of NS values that includes the specific-purpose NS value.

Clause 34. The computer-readable storage medium of clause 33, wherein apparatus supports a subset of the NS values, and the specific-purpose NS value is selected from the subset of the NS values that includes the specific-purpose NS value.

Clause 35. The computer-readable storage medium of clause 34, wherein the specific-purpose NS value is selected over at least one other NS value of the subset of the NS values.

Clause 36. The computer-readable storage medium of clause 34 or clause 35, wherein the NS values have an order in the list of NS values, the subset of the NS values includes multiple specific-purpose NS values, and the specific-purpose NS value selected is a first of the multiple specific-purpose NS values in the order.

Clause 37. The computer-readable storage medium of any of clauses 31 to 36, wherein the computer-readable storage medium has further computer-readable program code stored therein that, in response to execution by the processing circuitry, causes the apparatus to further receive one or more specific-purpose NS values, independent of the list of NS values, and wherein the specific-purpose NS value is selected from the one or more specific-purpose NS values.

Clause 38. The computer-readable storage medium of any of clauses 31 to 37, wherein the computer-readable storage medium has further computer-readable program code stored therein that, in response to execution by the processing circuitry, causes the apparatus to further at least: select an NS value from the list of NS values, the NS value associated with one of the respective emission requirements; apply one of the respective emission requirements associated with the NS value, for RF transmission by the apparatus; and establish access of the apparatus to the one or more specific-purpose features of the network, as the one of the respective emission requirements is applied, and wherein the specific-purpose NS value is selected based on the access of the apparatus.

Clause 39. The computer-readable storage medium of any of clauses 31 to 38, wherein the computer-readable storage medium has further computer-readable program code stored therein that, in response to execution by the processing circuitry, causes the apparatus to further determine at least one of a current time, an altitude or a location of the apparatus, and wherein the specific-purpose NS value is selected based on the at least one of the current time, the altitude or the location of the apparatus, the specific-purpose NS value associated with the emission requirement for RF transmission by the specific-purpose UE at the at least one of the current time, the altitude or the location.

Clause 40. The computer-readable storage medium of any of clauses 31 to 39, wherein the computer-readable storage medium has further computer-readable program code stored therein that, in response to execution by the processing circuitry, causes the apparatus to further at least: determine at least one of a current time, an altitude or a location of the apparatus, as the emission requirement is applied; select a second specific-purpose NS value, based on the at least one of the current time, the altitude or the location of the apparatus, the second specific-purpose NS value associated with a second emission requirement for RF transmission by the specific-purpose UE at the at least one of the current time, the altitude or the location; and apply the second emission requirement for RF transmission by the apparatus.

Clause 41. A apparatus comprising means for performing the method of any of clauses 21 to 30.

Clause 42. A computer-readable medium comprising computer-readable program code that, in response to execution by at least one processing circuitry, causes an apparatus to perform the method of any of clauses 21 to 30.

Clause 43. A computer-readable storage medium comprising computer-readable program code that, in response to execution by at least one processing circuitry, causes an apparatus to perform the method of any of clauses 21 to 30.

Clause 44. A computer program comprising computer-readable program code that, in response to execution by at least one processing circuitry, causes an apparatus to perform the method of any of clauses 21 to 30.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An apparatus comprising:
a memory configured to store computer-readable program code; and
processing circuitry configured to access the memory, and execute the computer-readable program code to cause the apparatus to at least:
receive system information at the apparatus operable in a network that serves a plurality of user equipments (UEs), the apparatus implemented as a specific-purpose UE that supports one or more specific-purpose features of the network, the system information including a list of network signaling (NS) values associated with respective emission requirements for radio frequency (RF) transmission by the plurality of UEs;
select a specific-purpose NS value associated with an emission requirement for RF transmission by the specific-purpose UE; and
apply the emission requirement for RF transmission by the apparatus.

2. The apparatus of claim 1, wherein the specific-purpose UE is an aerial UE, and the one or more specific-purpose features are aerial features of the network.

3. The apparatus of claim 1, wherein the specific-purpose NS value is selected from the list of NS values that includes the specific-purpose NS value.

4. The apparatus of claim 3, wherein the apparatus supports a subset of the NS values, and the specific-purpose NS value is selected from the subset of the NS values that includes the specific-purpose NS value.

5. The apparatus of claim 3, wherein the apparatus supports a subset of the NS values, and the specific-purpose NS value is selected from the subset of the NS values that includes the specific-purpose NS value, and wherein the specific-purpose NS value is selected over at least one other NS value of the subset of the NS values.

6. The apparatus of claim 4, wherein the apparatus supports a subset of the NS values, and the specific-purpose NS value is selected from the subset of the NS values that includes the specific-purpose NS value, and wherein the NS values have an order in the list of NS values, the subset of the NS values includes multiple specific-purpose NS values, and the specific-purpose NS value selected is a first of the multiple specific-purpose NS values in the order.

7. The apparatus of claim 1, wherein the processing circuitry is configured to execute the computer-readable program code to cause the apparatus to further:
receive one or more specific-purpose NS values, independent of the list of NS values, and
wherein the specific-purpose NS value is selected from the one or more specific-purpose NS values.

8. The apparatus of claim 1, wherein the processing circuitry is configured to execute the computer-readable program code to cause the apparatus to further at least:
select an NS value from the list of NS values, the NS value associated with one of the respective emission requirements;
apply one of the respective emission requirements associated with the NS value, for RF transmission by the apparatus; and
establish access of the apparatus to the one or more specific-purpose features of the network, as the one of the respective emission requirements is applied, and
wherein the specific-purpose NS value is selected based on the access of the apparatus.

9. The apparatus of claim 1, wherein the processing circuitry is configured to execute the computer-readable program code to cause the apparatus to further:
determine at least one of a current time, an altitude or a location of the apparatus, and
wherein the specific-purpose NS value is selected based on the at least one of the current time, the altitude or the location of the apparatus, the specific-purpose NS value associated with the emission requirement for RF transmission by the specific-purpose UE at the at least one of the current time, the altitude or the location.

10. The apparatus of claim 1, wherein the processing circuitry is configured to execute the computer-readable program code to cause the apparatus to further at least:
determine at least one of a current time, an altitude or a location of the apparatus, as the emission requirement is applied;
select a second specific-purpose NS value, based on the at least one of the current time, the altitude or the location of the apparatus, the second specific-purpose NS value associated with a second emission requirement for RF transmission by the specific-purpose UE at the at least one of the current time, the altitude or the location; and
apply the second emission requirement for RF transmission by the apparatus.

11. A method comprising:
receiving system information at a user equipment (UE) operable in a network that serves a plurality of UEs, the UE implemented as a specific-purpose that supports one or more specific-purpose features of the network, the system information including a list of network signaling (NS) values associated with respective emission requirements for radio frequency (RF) transmission by the plurality of UEs;
selecting a specific-purpose NS value at the specific-purpose UE, the specific-purpose NS value associated with an emission requirement for RF transmission by the specific-purpose UE; and
applying the emission requirement for RF transmission by the specific-purpose UE.

12. The method of claim 11, wherein the specific-purpose UE is an aerial UE, and the one or more specific-purpose features are aerial features of the network.

13. The method of claim 11, wherein the specific-purpose NS value is selected from the list of NS values that includes the specific-purpose NS value.

14. The method of claim 13, wherein the specific-purpose UE supports a subset of the NS values, and the specific-purpose NS value is selected from the subset of the NS values that includes the specific-purpose NS value.

15. The method of claim 13, wherein the specific-purpose UE supports a subset of the NS values, and the specific-purpose NS value is selected from the subset of the NS values that includes the specific-purpose NS value, and wherein the specific-purpose NS value is selected over at least one other NS value of the subset of the NS values.

16. The method of claim 13, wherein the specific-purpose UE supports a subset of the NS values, and the specific-purpose NS value is selected from the subset of the NS values that includes the specific-purpose NS value, and wherein the NS values have an order in the list of NS values, the subset of the NS values includes multiple specific-purpose NS values, and the specific-purpose NS value selected is a first of the multiple specific-purpose NS values in the order.

17. The method of claim 11, wherein the method further comprises:
receiving one or more specific-purpose NS values at the specific-purpose UE, independent of the list of NS values, and
wherein the specific-purpose NS value is selected from the one or more specific-purpose NS values.

18. The method of claim 11, wherein the method further comprises:
selecting an NS value from the list of NS values, the NS value associated with one of the respective emission requirements;
applying one of the respective emission requirements associated with the NS value, for RF transmission by the specific-purpose UE; and
establishing access of the specific-purpose UE to the one or more specific-purpose features of the network, as the one of the respective emission requirements is applied, and
wherein the specific-purpose NS value is selected based on the access of the specific-purpose UE.

19. The method of claim 11, wherein the method further comprises:
determining at least one of a current time, an altitude or a location of the specific-purpose UE, and
wherein the specific-purpose NS value is selected based on the at least one of the current time, the altitude or the location of the specific-purpose UE, the specific-purpose NS value associated with the emission requirement for RF transmission by the specific-purpose UE at the at least one of the current time, the altitude or the location.

20. The method of claim 11, wherein the method further comprises:
determining at least one of a current time, an altitude or a location of the specific-purpose UE, as the emission requirement is applied;
selecting a second specific-purpose NS value at the specific-purpose UE, based on the at least one of the current time, the altitude or the location of the specific-purpose UE, the second specific-purpose NS value associated with a second emission requirement for RF transmission by the specific-purpose UE at the at least one of the current time, the altitude or the location; and
applying the second emission requirement for RF transmission by the specific-purpose UE.
